(19) United States
(12) Patent Application Publication
(10) Pub. No.: US 2025/0305168 A1
(43) Pub. Date: Oct. 2, 2025

(54) MEMBRANES FOR USE IN ELECTROLYZERS AND PROCESSES FOR MAKING THE SAME

(71) Applicant: OHMIUM INTERNATIONAL, INC., Newark, CA (US)

(72) Inventors: Bhuvaneswari Subramani, Kanchipuram (IN); Pratheeksha Parakandy Muzhikara, Fremont, CA (US); Vinod Selvaganesh Sivasuriyanarayanan, Chennai (IN)

(21) Appl. No.: 19/092,694

(22) Filed: Mar. 27, 2025

Related U.S. Application Data
(60) Provisional application No. 63/570,543, filed on Mar. 27, 2024.

(51) Int. Cl. C25B 13/08; C25B 9/23; C25B 11/052; C25B 13/02

(52) U.S. Cl. CPC C25B 13/08; C25B 9/23; C25B 11/052; C25B 13/02

(57) ABSTRACT

The present disclosure provides composite ion exchange membranes and methods of making the same. The composite ion exchange membranes of the present disclosure generally include a first and second coating layer comprising an ionomer and a catalyst coated on opposite sides of a reinforcing polymer sheet, and a third and fourth coating layer comprising an ionomer coated on the first and second coating layers. The first and second coating layers may be coated on the reinforcing polymer sheet via doctor blade casting or dip coating techniques. The catalyst may be incorporated within the first and second coating layers of the composite ion exchange membrane using in situ or ex situ techniques.

### CROSS-REFERENCE TO RELATED APPLICATIONS

This application claims priority to U.S. Provisional Application No. 63/570,543 titled “MEMBRANES FOR USE IN ELECTROLYZERS AND PROCESSES FOR MAKING THE SAME”, filed Mar. 27, 2024, the entire contents of which are incorporated by reference herein.

### FIELD OF THE DISCLOSURE

The present disclosure is related to ion-exchange membranes for use in electrolyzers and methods of making and using the same.

### BACKGROUND

Electrolyzers use a polymer-based ion conducting membrane to separate ions, particularly hydrogen ions and hydroxy anions. The performance of the electrolyzer may be defined in part by the power density of the membrane, which refers to the amount of power per unit area that can be supported by the membrane at a given voltage. As power density increases, the surface area of the ion-conducting membrane is required to support the same voltage a given output of hydrogen can be reduced. Thinner ion-conducting membranes have lower resistance and thus enables increased power density. However, thinner membranes also increase the flux of hydrogen and oxygen permeation, thereby resulting in less pure gas product streams. What is needed is an ion conducting membrane with increased power density and low flux of hydrogen and oxygen permeation.

### SUMMARY OF THE DISCLOSURE

Provided herein are composite ion exchange membranes and methods of making thereof. The composite ion exchange membranes generally comprise a reinforcing polymer sheet having a first planar surface and a second planar surface, wherein the first planar surface is opposite to the second planar surface; a first coating layer including a catalyst and an ionomer, wherein the first coating layer is coated on the first planar surface of the reinforcing polymer sheet; a second coating layer including a catalyst and an ionomer, wherein the first coating layer is coated on the second planar surface of the reinforcing polymer sheet; a third coating layer including an ionomer, wherein the third coating layer is coated on the first coating layer; and a fourth coating layer including an ionomer, wherein the fourth coating layer is coated on the second coating layer. The composite ion exchange membrane may comprise a reinforcing polymer sheet having a first planar surface and a second planar surface, wherein the first planar surface is opposite to the second planar surface; a first coating layer including a catalyst and an ionomer, wherein the first coating layer is coated on the first planar surface of the reinforcing polymer sheet; a second coating layer including a catalyst and an ionomer, wherein the first coating layer is coated on the second planar surface of the reinforcing polymer sheet; a third coating layer including an ionomer, wherein the third coating layer is coated on the first coating layer; and a fourth coating layer including an ionomer, wherein the fourth coating layer is coated on the second coating layer. The composite ion exchange membrane is suitable for use in fuel cells, electrolyzers, and/or metal-air batteries.

In some embodiments, the reinforcing polymer sheet includes poly(1,1,2,2-tetrafluoroethylene) (e-PTFE), poly(ether ether ketone) (PEEK), or sulfonated poly(ether ether ketone) (sPEEK). In yet another embodiment, the reinforcing polymer sheet has a thickness from about 10 to about 40 microns. In some embodiments, the first layer has a thickness from about 15 to about 30 microns. In some embodiments, the second layer has a thickness from about 15 to about 30 microns. In some embodiments, the composite ion exchange membrane has a thickness from 20 to about 150 microns.

In some embodiments, the catalyst is present in the first layer in an amount from about 1 wt % to about 5 wt %. The catalyst may comprise a scavenging catalyst. For example, the scavenging catalyst may comprise Au, Ag, Ni, Pt, ZrO₂, TiO₂, SiO₂, or CeO₂. In one embodiment, the catalyst comprises Pt. In some embodiments, the catalyst is uniformly distributed throughout the first coating layer and reinforcing polymer sheet. The catalyst may be present in the membrane with an area density of about 10-100 μg/cm².

In some embodiments, the ionomer is a perfluorosulfonic acid (PSFA) ionomer. The PSFA ionomer may be a tetrafluoroethylene-based fluoropolymer-copolymer. The ionomer may further be selected from the group consisting of, SPEEK, PVA-PSSA, Chitosan, any combination thereof.

In another embodiment, the composite ion exchange membrane has a reinforcing polymer sheet having a surface area; a first coating layer including a catalyst and an ionomer, wherein the first coating layer fully coats the entire surface area of the reinforcing polymer sheet; and a second coating layer including an ionomer, wherein the second coating layer fully coats the first coating layer. In another embodiment, the reinforcing polymer sheet includes poly(1,1,2,2-tetrafluoroethylene) (e-PTFE), poly(ether ether ketone) (PEEK), or sulfonated poly(ether ether ketone) (sPEEK). In some embodiments, the reinforcing polymer sheet has a thickness from about 10 to about 40 microns. In some embodiments, the first layer has a thickness from about 15 to about 30 microns. In some embodiments, the composite ion exchange membrane has a thickness from 20 to about 150 microns. The composite ion exchange membrane is suitable for use in fuel cells, electrolyzers, and/or metal-air batteries.

Further provided herein are methods for making a composite ion exchange membrane. The methods generally comprise coating a first planar surface of a reinforcing polymer sheet with a first solution including an ionomer and a catalyst precursor solution, coating a second planar surface of a reinforcing polymer sheet with a second solution including an ionomer and a catalyst precursor solution, thereby forming a coated reinforcing polymer sheet having a first coating layer on the first planar surface and a second coating layer on the second planar surface; drying the coated reinforcing polymer sheet; immersing the coated reinforcing polymer sheet in a reducing solution; coating the first coating layer of the coated reinforcing polymer sheet with a third solution including an ionomer; coating the second coating layer of the coated reinforcing polymer sheet with a fourth solution including an ionomer, thereby forming an ionomer-coated reinforcing polymer sheet; and drying the ionomer-coated reinforcing polymer sheet.

In some embodiments, the membrane is immersed in the reducing solution for about 5 minutes to about 45 minutes. The reducing solution may include a reducing agent comprising NaBH₄, N₂H₄, CH₃COOH, or NaHCO₃. In another embodiment, the reducing solution includes NaBH₄ having a concentration from about 0.01 M to about 0.5 M.

In some embodiments, drying the coated reinforcing polymer sheet occurs at a temperature of about 50 to about 60° C. for about 5 minutes to about 15 minutes before immersing the membrane in the reducing solution. In another embodiment, drying the ionomer-coated reinforcing polymer sheet is performed at two different temperatures. In some embodiments, the membrane is first dried at a temperature from about 60° C. to about 80° C. for about 12 hours to about 16 hours and then dried at a temperature of about 120° C. to about 140° C. for about 2 hours to about 4 hours.

In some embodiments, the method further includes making a composite ion exchange membrane further comprises rinsing the coated reinforcing polymer sheet after the immersing. In yet another embodiment, the method may further comprise drying the coated reinforcing polymer sheet after the immersing.

In another embodiment, the methods further comprise mixing an ionomer solution with a catalyst precursor solution for about 30 to about 60 minutes to form the first solution.

In some embodiments, coating the first planar surface and second planar surface of the reinforcing polymer sheet is accomplished by doctor blade casting the first solution onto the reinforcing polymer sheet. In another embodiment, coating the first planar surface and second planar surface of the reinforcing polymer sheet is accomplished by dip coating, wherein the first solution and the second solution are the same solution.

In another embodiment, a method of making a composite ion exchange membrane comprises coating a first planar surface of a reinforcing polymer sheet with a first solution comprising an ionomer; coating a second planar surface of the reinforcing polymer sheet with a second solution comprising an ionomer, thereby forming a coated reinforcing polymer sheet having a first coating layer on the first planar surface and a second coating layer on the second planar surface, wherein the first planar surface is opposite to the second planar surface; immersing the coated reinforcing polymer sheet in a catalyst precursor solution to incorporate the catalyst within the first coating layer and second coating layer; drying the coated reinforcing polymer sheet; immersing the coated reinforcing polymer sheet in a reducing solution; coating the first coating layer of the coated reinforcing polymer sheet with a third solution comprising an ionomer; coating the second coating layer of the coating reinforcing polymer sheet with a fourth solution comprising an ionomer, thereby forming an ionomer-coated reinforcing polymer sheet; and drying the ionomer-coated reinforcing polymer sheet.

In some embodiments, the membrane is immersed in the reducing solution for about 5 minutes to about 45 minutes. The reducing solution may include a reducing agent comprising NaBH₄, N₂H₄, CH₃COOH, or NaHCO₃. In another embodiment, the reducing solution includes NaBH₄ having a concentration from about 0.01 M to about 0.5 M.

In some embodiments drying the coated reinforcing polymer sheet occurs at a temperature of about 50 to about 60° C. for about 5 minutes to about 15 minutes before immersing the membrane in the reducing solution. In another embodiment, drying the ionomer-coated reinforcing polymer sheet is performed at two different temperatures. In some embodiments, the membrane is first dried at a temperature from about 60° C. to about 80° C. for about 12 hours to about 16 hours and then dried at a temperature of about 120° C. to about 140° C. for about 2 hours to about 4 hours.

In some embodiments, the method for making a composite ion exchange membrane further comprises rinsing the coated reinforcing polymer sheet after the immersing. In yet another embodiment, the method may further comprise drying the coated reinforcing polymer sheet after the immersing.

In some embodiments coating the first planar surface and second planar surface of the reinforcing polymer sheet is accomplished by doctor blade casting the first solution onto the reinforcing polymer sheet. The first solution may comprise from about 20-22 wt % ionomer. In other embodiments, coating the first planar surface and second planar surface of the reinforcing polymer sheet is accomplished by dip coating, wherein the first solution and the second solution are the same solution. The dip coating may comprise immersing the reinforcing polymer sheet in the solution for about 1 hour to about 12 hours.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows a graphical representation of a cross-section of a composite ion exchange membrane of the present disclosure.

FIG. 2A shows a graphical representation of a cross-section of a fully coated composite ion exchange membrane of the present disclosure.

FIG. 2B shows a graphical representation of a cross-section of a hybrid composite ion exchange membrane of the present disclosure.

FIG. 3 shows a graphical representation of an in-situ doctor blade casting method for making a composite ion exchange membrane of the present disclosure.

FIG. 4 shows a graphical representation of an in-situ dip coating method for making a composite ion exchange membrane of the present disclosure.

FIG. 5 shows a graphical representation of an ex-situ doctor blade casting method for making a composite ion exchange membrane of the present disclosure.

FIG. 6 shows a graphical representation of an ex-situ dip coating method for making a composite ion exchange membrane of the present disclosure.

Corresponding reference characters indicate corresponding elements among the view of the drawings. The headings used in the figures do not limit the scope of the claims.

### DETAILED DESCRIPTION

### 1. Composite Ion Exchange Membranes

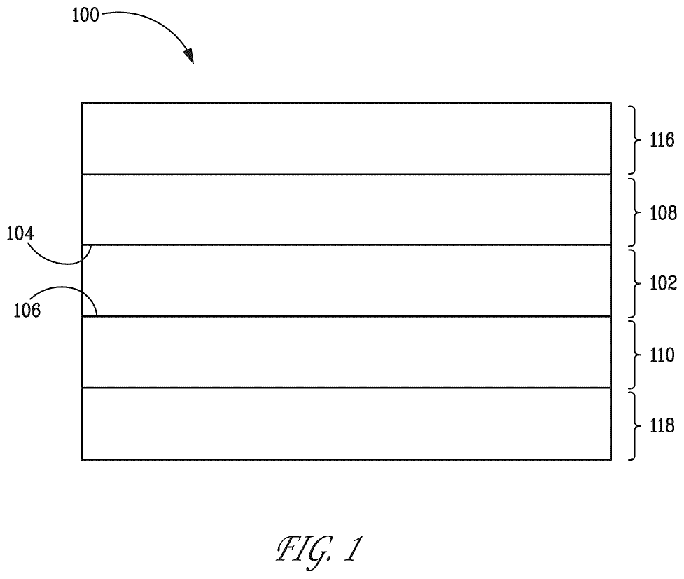

Described herein are composite ion exchange membranes and methods of making thereof. As depicted by FIG. 1, the composite ion exchange membranes provided herein generally include a reinforcing polymer sheet 102, a first coating layer 108 coated on a first planar surface 104 of the reinforcing polymer sheet, a second coating layer 110 coated on a second planar surface 106 of the reinforcing polymer sheet, a third coating layer 116 coated on the first coating layer, and a fourth coating layer 118 coated on the second coating layer. The first coating layer 108 and second coating layer 110 each generally include a catalyst and an ionomer, and the third coating layer 116 and fourth coating layer 118 each generally include an ionomer.

It has been surprisingly found that including the reinforcing polymer sheet 102 reduces residual stress and crack formation across the composite ion exchange membrane. It has also been surprisingly found that including a catalyst within the first coating layer 108 and second coating layer 110 of the composite ion exchange membrane 100 enhances performance of the membrane without excessive gas cross-over. Therefore, the composite ion exchange membranes of the present disclosure are more durable and have an increased power efficiency as compared to ion exchange membranes of the prior art.

The composite ion exchange membrane 100 has a total thickness from about 20 microns to about 150 microns. For example, the composite ion exchange membrane 100 may have a total thickness from about 20 microns to about 30 microns, about 20 microns to about 40 microns, about 20 microns to about 50 microns, about 20 microns to about 60 microns, about 20 microns to about 70 microns, about 20 microns to about 80 microns, about 20 microns to about 90 microns, about 20 microns to about 100 microns, about 20 microns to about 110 microns, about 20 microns to about 120 microns, about 20 microns to about 130 microns, about 20 microns to about 140 microns, about 20 microns to about 150 microns, about 30 microns to about 150 microns, about 40 microns to about 150 microns, about 50 microns to about 150 microns, about 60 microns to about 150 microns, about 70 microns to about 150 microns, about 80 microns to about 150 microns, about 90 microns to about 150 microns, about 100 microns to about 150 microns, about 110 microns to about 150 microns, about 120 microns to about 150 microns, about 130 microns to about 150 microns, about 140 microns to about 150 microns, about 30 microns to about 40 microns, about 40 microns to about 50 microns, about 50 microns to about 60 microns, about 60 microns to about 70 microns, about 80 microns to about 90 microns, about 90 microns to about 100 microns, about 100 microns to about 110 microns, about 110 microns to about 120 microns, about 120 microns to about 130 microns, or about 130 microns to about 140 microns. As another example, the composite ion exchange membrane 100 may have a total thickness of about 20 microns, about 30 microns, about 40 microns, about 50 microns, about 60 microns, about 70 microns, about 80 microns, about 90 microns, about 100 microns, about 110 microns, about 120 microns, about 130 microns, about 140 microns, or about 150 microns.

The reinforcing polymer sheet 102 may have a thickness from about 10 microns to about 40 microns. For example, the reinforcing polymer sheet 102 may have a thickness from about 10 microns to about 15 microns, about 10 microns to about 20 microns, about 10 microns to about 25 microns, about 10 microns to about 30 microns, about 10 microns to about 35 microns, about 10 microns to about 40 microns, about 15 microns to about 40 microns, about 20 microns to about 40 microns, about 25 microns to about 40 microns, about 30 microns to about 40 microns, about 35 microns to about 40 microns, about 15 microns to about 20 microns, about 20 microns to about 25 microns, about 25 microns to about 30 microns, or about 30 microns to about 35 microns. As another example, the reinforcing polymer sheet 102 may have a thickness of about 10 microns, about 15 microns, about 20 microns, about 25 microns, about 30 microns, about 35 microns, or about 40 microns.

The first coating layer 108 may have a thickness from about 15 microns to about 30 microns. For example, the first coating layer may have a thickness from about 15 microns to about 20 microns, about 15 microns to about 25 microns, about 15 microns to about 30 microns, about 20 microns, to about 30 microns, about 25 microns to about 30 microns, or about 20 to about 25 microns. As another example, the first coating layer 108 may have a thickness of about 15 microns, about 20 microns, about 25 microns, or about 30 microns.

The second coating layer 110 may have a thickness from about 15 microns to about 30 microns. For example, the second coating layer may have a thickness from about 15 microns to about 20 microns, about 15 microns to about 25 microns, about 15 microns to about 30 microns, about 20 microns, to about 30 microns, about 25 microns to about 30 microns, or about 20 to about 25 microns. As another example, the second coating layer 110 may have a thickness of about 15 microns, about 20 microns, about 25 microns, or about 30 microns.

The third coating layer 116 may have a thickness from about 5 microns to about 10 microns. For example, the third coating layer 116 may have a thickness from about 5 microns to about 6 microns, about 5 microns to about 7 microns, about 5 microns to about 8 microns, about 5 microns, to about 9 microns, about 5 microns to about 10 microns, about 6 microns to about 10 microns, about 7 microns to about 10 microns, about 8 microns to about 10 microns, about 9 microns to about 10 microns, about 6 microns to about 7 microns, about 7 microns to about 8 microns, or about 8 microns to about 9 microns. As another example, the third coating layer 116 may have a thickness of about 5 microns, about 6 microns, about 7 microns, about 8 microns, about 9 microns, or about 10 microns.

The fourth coating layer 118 may have a thickness from about 5 microns to about 20 microns. For example, the fourth coating layer 118 may have a thickness from about 5 microns to about 10 microns, about 5 microns to about 15 microns, about 5 microns to about 20 microns, about 100 microns to about 20 microns, about 15 microns to about 20 microns, or about 10 to about 15 microns. As another example, the fourth coating layer 118 may have a thickness of about 5 microns, about 10 microns, about 15 microns, or about 20 microns.

The reinforcing polymer sheet 102 may include poly(1,1,2,2-tetrafluoroethylene) (e-PTFE), poly(ether ether ketone) (PEEK), sulfonated poly(ether ether ketone) (sPEEK), or any other polymer having a mechanical strength suitable to provide reinforcement to the composite ion exchange membrane 100, or a combination thereof. The reinforcing polymer sheet 102 may have any shape, such as circular, elliptical, triangular, rectangular, square, pentagonal, hexagonal, etc. The reinforcing polymer sheet 102 may further comprise a first planar surface 104 and a second planar surface 106, wherein the second planar surface 106 is positioned opposite to the first planar surface 104 on the surface area of the reinforcing polymer sheet 102.

The reinforcing polymer sheet 102 may further comprise a catalyst. The catalyst increases reactivity of hydrogen and oxygen gas. The catalyst may include a scavenging catalyst such as gold (Au), silver (Ag), nickel (Ni), platinum (Pt), zirconium dioxide (ZrO₂), titanium dioxide (TiO₂), silicon dioxide (SiO₂), or a combination thereof. In one example, the catalyst comprises Pt.

The catalyst may be present in the reinforcing polymer sheet 102 in an amount from about 1 wt % to about 2 wt %, about 1 wt % to about 3 wt %, about 1 wt % to about 4 wt %, about 1 wt % to about 5 wt %, about 2 wt % to about 5 wt %, about 3 wt % to about 5 wt %, about 4 wt % to about 5 wt %, about 2 wt % to about 3 wt %, or about 3 wt % to about 4 wt %. As an additional example, the catalyst may be present in the reinforcing polymer sheet 102 in an amount of about 1 wt %, about 2 wt %, about 3 wt %, about 4 wt %, or about 5 wt %.

The catalyst may be present in the reinforcing polymer sheet 102 of the composite ion exchange membrane 100 with an area density from about 10 μg/cm² to about 100 μg/cm². For example, the catalyst may be present in the reinforcing polymer sheet 102 in a concentration from about 10 μg/cm² to about 20 μg/cm², about 10 μg/cm² to about 30 μg/cm², about 10 μg/cm² to about 40 μg/cm², about 10 μg/cm² to about 50 μg/cm², about 10 μg/cm² to about 60 μg/cm², about 10 μg/cm² to about 70 μg/cm², about 10 μg/cm² to about 80 μg/cm², about 10 μg/cm² to about 90 μg/cm², about 10 μg/cm² to about 100 μg/cm², about 20 μg/cm² to about 100 μg/cm², about 30 μg/cm² to about 100 μg/cm², about 40 μg/cm² to about 100 μg/cm², about 50 μg/cm² to about 100 μg/cm², about 60 μg/cm² to about 100 μg/cm², about 70 μg/cm² to about 100 μg/cm², about 80 μg/cm² to about 100 μg/cm², about 90 μg/cm² to about 100 μg/cm², about 20 μg/cm² to about 30 μg/cm², about 30 μg/cm² to about 40 μg/cm², about 40 μg/cm² to about 50 μg/cm², about 50 μg/cm² to about 60 μg/cm², about 60 μg/cm² to about 70 μg/cm², about 70 μg/cm² to about 80 μg/cm², or about 80 μg/cm² to about 90 μg/cm². As another example, the catalyst may be present in the reinforcing polymer sheet 102 with an area density of about 10 μg/cm², 20 μg/cm², 30 μg/cm², 40 μg/cm², 50 μg/cm², 60 μg/cm², 70 μg/cm², 80 μg/cm², 90 μg/cm², or 100 μg/cm². In an example, the catalyst may be present in the reinforcing polymer sheet 102 with an area density of about 45 μg/cm². Preferably, the catalyst is uniformly distributed throughout the reinforcing polymer sheet 102.

The first coating layer 108 and the second coating layer 110 each generally comprise an ionomer. The ionomer in each of the first coating layer 108 and the second coating layers 110 is oxidatively stable and facilitates the transfer of ions produced in an electrolysis process by the formation of an interconnected network of hydrophilic domains upon hydration of the composite ion exchange membrane 100, which allow movement of water and cations. For example, the composite ion exchange membrane 100 may be capable of conducting protons (H⁺) and/or hydroxide ions (OH⁻). In some embodiments, the ionomer of the first coating layer 108 may be the same ionomer of the second coating layer 110. In other embodiments, the ionomer of the first coating layer 108 may be different from the ionomer of the second coating layer 110. The ionomer may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer may have the formula C₇HF₁₃O₅S·CₙF₂ₙ, where n is an integer from 3,000 to 10,000. As another example, the ionomer may include Nafion™. In another embodiment, the ionomer is chosen such that the composite ion exchange membrane 100 has a conductivity of about 100 mS/cm.

The first coating layer 108, second coating layer 110, or both may further comprise a catalyst. The catalyst functions to increase reactivity of hydrogen and oxygen gas. The catalyst may include a scavenging catalyst such as gold (Au), silver (Ag), nickel (Ni), platinum (Pt), zirconium dioxide (ZrO₂), titanium dioxide (TiO₂), silicon dioxide (SiO₂), or a combination thereof. In one example, the catalyst comprises Pt.

The catalyst may be present in the first coating layer 108 in an amount from about 1 wt % to about 2 wt %, about 1 wt % to about 3 wt %, about 1 wt % to about 4 wt %, about 1 wt % to about 5 wt %, about 2 wt % to about 5 wt %, about 3 wt % to about 5 wt %, about 4 wt % to about 5 wt %, about 2 wt % to about 3 wt %, or about 3 wt % to about 4 wt %. As an additional example, the catalyst may be present in the first coating layer 108 in an amount of about 1 wt %, about 2 wt %, about 3 wt %, about 4 wt %, or about 5 wt %.

The catalyst may be present in the second coating layer 110 in an amount from about 1 wt % to about 2 wt %, about 1 wt % to about 3 wt %, about 1 wt % to about 4 wt %, about 1 wt % to about 5 wt %, about 2 wt % to about 5 wt %, about 3 wt % to about 5 wt %, about 4 wt % to about 5 wt %, about 2 wt % to about 3 wt %, or about 3 wt % to about 4 wt %. As an additional example, the catalyst may be present in the second coating layer 110 in an amount of about 1 wt %, about 2 wt %, about 3 wt %, about 4 wt %, or about 5 wt %.

The catalyst may be present in the first coating layer 108 of the composite ion exchange membrane 100 with an area density from about 10 μg/cm² to about 100 μg/cm². For example, the catalyst may be present in the first coating layer 108 in a concentration from about 10 μg/cm² to about 20 μg/cm², about 10 μg/cm² to about 30 μg/cm², about 10 μg/cm² to about 40 μg/cm², about 10 μg/cm² to about 50 μg/cm², about 10 μg/cm² to about 60 μg/cm², about 10 μg/cm² to about 70 μg/cm², about 10 μg/cm² to about 80 μg/cm², about 10 μg/cm² to about 90 μg/cm², about 10 μg/cm² to about 100 μg/cm², about 20 μg/cm² to about 100 μg/cm², about 30 μg/cm² to about 100 μg/cm², about 40 μg/cm² to about 100 μg/cm², about 50 μg/cm² to about 100 μg/cm², about 60 μg/cm² to about 100 μg/cm², about 70 μg/cm² to about 100 μg/cm², about 80 μg/cm² to about 100 μg/cm², about 90 μg/cm² to about 100 μg/cm², about 20 μg/cm² to about 30 μg/cm², about 30 μg/cm² to about 40 μg/cm², about 40 μg/cm² to about 50 μg/cm², about 50 μg/cm² to about 60 μg/cm², about 60 μg/cm² to about 70 μg/cm², about 70 μg/cm² to about 80 μg/cm², or about 80 μg/cm² to about 90 μg/cm². As another example, the catalyst may be present in the first coating layer 108 with an area density of about 10 μg/cm², 20 μg/cm², 30 μg/cm², 40 μg/cm², 50 μg/cm², 60 μg/cm², 70 μg/cm², 80 μg/cm², 90 μg/cm², or 100 μg/cm². In an example, the catalyst may be present in the first coating layer 108 with an area density of about 45 μg/cm². Preferably, the catalyst is uniformly distributed throughout the first coating layer 108.

The catalyst may be present in the second coating layer 110 of the composite ion exchange membrane 100 with an area density from about 10 μg/cm² to about 100 μg/cm². For example, the catalyst may be present in the second coating layer 110 in a concentration from about 10 μg/cm² to about 20 μg/cm², about 10 μg/cm² to about 30 μg/cm², about 10 μg/cm² to about 40 μg/cm², about 10 μg/cm² to about 50 μg/cm², about 10 μg/cm² to about 60 μg/cm², about 10 μg/cm² to about 70 μg/cm², about 10 μg/cm² to about 80 μg/cm², about 10 μg/cm² to about 90 μg/cm², about 10 μg/cm² to about 100 μg/cm², about 20 μg/cm² to about 100 μg/cm², about 30 μg/cm² to about 100 μg/cm², about 40 μg/cm² to about 100 μg/cm², about 50 μg/cm² to about 100 μg/cm², about 60 μg/cm² to about 100 μg/cm², about 70 μg/cm² to about 100 μg/cm², about 80 μg/cm² to about 100 μg/cm², about 90 μg/cm² to about 100 μg/cm², about 20 μg/cm² to about 30 μg/cm², about 30 μg/cm² to about 40 μg/cm², about 40 μg/cm² to about 50 μg/cm², about 50 μg/cm² to about 60 μg/cm², about 60 μg/cm² to about 70 μg/cm², about 70 μg/cm² to about 80 μg/cm², or about 80 μg/cm² to about 90 μg/cm². As another example, the catalyst may be present in the second coating layer 108 with an area density of about 10 μg/cm², 20 μg/cm², 30 μg/cm², 40 μg/cm², 50 μg/cm², 60 μg/cm², 70 μg/cm², 80 μg/cm², 90 μg/cm², or 100 μg/cm². In an example, the catalyst is present in the second coating layer 110 with an area density of about 45 μg/cm². Preferably, the catalyst is uniformly distributed throughout the second coating layer 110.

The third coating layer 116 and the fourth coating layer 118 each generally comprise an ionomer. The ionomer in the third coating layer 116 and the fourth coating layer 118 is oxidatively stable and facilitates the transfer of ions produced in an electrolysis process by the formation of an interconnected network of hydrophilic domains upon hydration of the composite ion exchange membrane 100, which allow movement of water and cations. For example, the composite ion exchange membrane 100 may be capable of conducting protons (H⁺) and/or hydroxide ions (OH⁻). The ionomer of the third coating layer 116 may be the same ionomer of the fourth coating layer 118; alternatively, the ionomer of the third coating layer 116 may differ from the ionomer of the fourth coating layer 118. The ionomer of the third coating layer 116, the fourth coating layer 118, or both may be the same ionomer in the first coating layer 108 or the second coating layer 110.

The ionomer may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer may have the formula C₇HF₁₃O₅S·CₙF₂ₙ, where n is an integer from 3,000 to 10,000. As another example, the ionomer may include Nafion™. In another embodiment, the ionomer may be such that composite ion exchange membrane 100 has a conductivity of about 100 mS/cm.

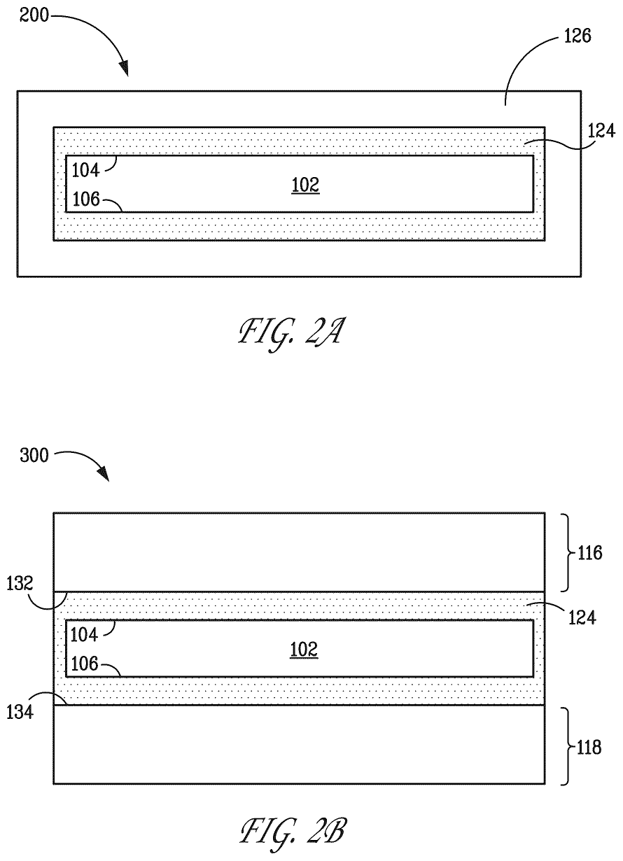

Turning now to FIG. 2A, further provided herein is a fully-coated composite ion exchange membrane 200 that includes a first full coating layer 124 that fully coats the entire surface area of the reinforcing polymer sheet 102; i.e., the first full coating layer 124 forms a complete coating surrounding the reinforcing polymer sheet 102.

The first full coating layer 124 generally comprises an ionomer. The ionomer in the first full coating layer 124 is oxidatively stable and facilitates the transfer of ions produced in an electrolysis process by the formation of an interconnected network of hydrophilic domains upon hydration of the composite ion exchange membrane 100, which allow movement of water and cations. For example, the composite ion exchange membrane 100 may be capable of conducting protons (H⁺) and/or hydroxide ions (OH⁻). The ionomer may include perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™. In another embodiment, the ionomer may be such that the first full coating layer 124 has a conductivity of about 100 mS/cm.

The first full coating layer 124 may further comprise a catalyst. The catalyst functions to increase reactivity of hydrogen and oxygen gas. The catalyst may, in some embodiments, be a scavenging catalyst such as gold (Au), silver (Ag), nickel (Ni), platinum (Pt), zirconium dioxide (ZrO₂), titanium dioxide (TiO₂), silicon dioxide (SiO₂), or a combination thereof. In one example, the catalyst comprises Pt.

The catalyst may be present in the first full coating layer 124 in an amount from about 1 wt % to about 2 wt %, about 1 wt % to about 3 wt %, about 1 wt % to about 4 wt %, about 1 wt % to about 5 wt %, about 2 wt % to about 5 wt %, about 3 wt % to about 5 wt %, about 4 wt % to about 5 wt %, about 2 wt % to about 3 wt %, or about 3 wt % to about 4 wt %. As an additional example, the catalyst may be present in the first full coating layer 124 in an amount of about 1 wt %, about 2 wt %, about 3 wt %, about 4 wt %, or about 5 wt %.

The catalyst may be present in the first full coating layer 124 of the composite ion exchange membrane 100 with an area density from about 10 μg/cm² to about 100 μg/cm². For example, the catalyst may be present in the first full coating layer 124 in a concentration from about 10 μg/cm² to about 20 μg/cm², about 10 μg/cm² to about 30 μg/cm², about 10 μg/cm² to about 40 μg/cm², about 10 μg/cm² to about 50 μg/cm², about 10 μg/cm² to about 60 μg/cm², about 10 μg/cm² to about 70 μg/cm², about 10 μg/cm² to about 80 μg/cm², about 10 μg/cm² to about 90 μg/cm², about 10 μg/cm² to about 100 μg/cm², about 20 μg/cm² to about 100 μg/cm², about 30 μg/cm² to about 100 μg/cm², about 40 μg/cm² to about 100 μg/cm², about 50 μg/cm² to about 100 μg/cm², about 60 μg/cm² to about 100 μg/cm², about 70 μg/cm² to about 100 μg/cm², about 80 μg/cm² to about 100 μg/cm², about 90 μg/cm² to about 100 μg/cm², about 20 μg/cm² to about 30 μg/cm², about 30 μg/cm² to about 40 μg/cm², about 40 μg/cm² to about 50 μg/cm², about 50 μg/cm² to about 60 μg/cm², about 60 μg/cm² to about 70 μg/cm², about 70 μg/cm² to about 80 μg/cm², or about 80 μg/cm² to about 90 μg/cm². As another example, the catalyst may be present in the first full coating layer 124 with an area density of about 10 μg/cm², 20 μg/cm², 30 μg/cm², 40 μg/cm², 50 μg/cm², 60 μg/cm², 70 μg/cm², 80 μg/cm², 90 μg/cm², or about 100 μg/cm². In an example, the catalyst may be present in the first full coating layer 124 with an area density of about 45 μg/cm². Preferably, the catalyst is uniformly distributed throughout the first full coating layer 124.

The fully coated composite ion exchange membrane 200 further includes a second full coating layer 126 that is coated on the first coating layer 124. The second full coating layer 126 generally comprises an ionomer. The ionomer in the second full coating layer 126 is oxidatively stable and facilitates the transfer of ions produced in an electrolysis process by the formation of an interconnected network of hydrophilic domains upon hydration of the composite ion exchange membrane 100, which allow movement of water and cations. For example, the composite ion exchange membrane 100 may be capable of conducting protons (H⁺) and/or hydroxide ions (OH⁻). In one embodiment, the ionomer of the second full coating layer 126 may be the same ionomer of the first full coating layer 124. In one embodiment, the ionomer may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™. In another embodiment, the ionomer is such that the second full coating layer 126 has a conductivity of about 100 mS/cm.

The fully-coated composite ion exchange membrane 200 of FIG. 2A may have a total thickness from about 20 to about 30 microns, about 20 to about 40 microns, about 20 to about 50 microns, about 20 to about 60 microns, about 20 to about 70 microns, about 20 to about 80 microns, about 20 to about 90 microns, about 20 to about 100 microns, about 20 to about 110 microns, about 20 to about 120 microns, about 20 to about 130 microns, about 20 to about 140 microns, about 20 to about 150 microns, about 30 microns to about 150 microns, about 40 microns to about 150 microns, about 50 microns to about 150 microns, about 60 microns to about 150 microns, about 70 microns to about 150 microns, about 80 microns to about 150 microns, about 90 microns to about 150 microns, about 100 microns to about 150 microns, about 110 microns to about 150 microns, about 120 microns to about 150 microns, about 130 microns to about 150 microns, about 140 microns to about 150 microns, about 30 microns to about 40 microns, about 40 microns to about 50 microns, about 50 microns to about 60 microns, about 60 microns to about 70 microns, about 80 microns to about 90 microns, about 90 microns to about 100 microns, about 100 microns to about 110 microns, about 110 microns to about 120 microns, about 120 microns to about 130 microns, or about 130 microns to about 140 microns. As another example, the composite ion exchange membrane 100 may have a total thickness of about 20 microns, about 30 microns, about 40 microns, about 50 microns, about 60 microns, about 70 microns, about 80 microns, about 90 microns, about 100 microns, about 110 microns, about 120 microns, about 130 microns, about 140 microns, or about 150 microns.

The reinforcing polymer sheet 102 may have a thickness from about 10 microns to about 40 microns. For example, the reinforcing polymer sheet 102 may have a thickness from about 10 microns to about 15 microns, about 10 microns to about 20 microns, about 10 microns to about 25 microns, about 10 microns to about 30 microns, about 10 microns to about 35 microns, about 10 microns to about 40 microns, about 15 microns to about 40 microns, about 20 microns to about 40 microns, about 25 microns to about 40 microns, about 30 microns to about 40 microns, about 35 microns to about 40 microns, about 15 microns to about 20 microns, about 20 microns to about 25 microns, about 25 microns to about 30 microns, or about 30 microns to about 35 microns. As another example, the reinforcing polymer sheet may have a thickness of about 10 microns, about 15 microns, about 20 microns, about 25 microns, about 30 microns, about 35 microns, or about 40 microns.

The first full coating layer 124 may have a thickness from about 15 microns to about 30 microns. For example, the first full coating layer 124 may have a thickness from about 15 microns to about 20 microns, about 15 microns to about 25 microns, about 15 microns to about 30 microns, about 20 microns, to about 30 microns, about 25 microns to about 30 microns, or about 20 to about 25 microns. As another example, the first full coating layer 124 may have a thickness of about 15 microns, about 20 microns, about 25 microns, or about 30 microns.

The second full coating layer 126 may have a thickness from about 5 microns to about 20 microns. For example, the second full coating layer 126 may have a thickness from about 5 microns to about 10 microns, about 5 microns to about 15 microns, about 5 microns to about 20 microns, about 100 microns to about 20 microns, about 15 microns to about 20 microns, or about 10 to about 15 microns. As another example, the second full coating layer 126 may have a thickness of about 5 microns, about 10 microns, about 15 microns, or about 20 microns.

As an alternative to the second full coating layer 126, the composite ion exchange membrane may instead comprise a third coating layer 116 and a fourth coating layer 118 as shown in the hybrid composite ion exchange membrane 300 shown in FIG. 2B. The third coating layer 116 may be coated on a first planar surface 132 of the first full coating layer 124 and the fourth layer 118 may be coated on a second planar surface 134 of the first full coating layer opposite the first planar surface of the first full coating layer.

The hybrid composite ion exchange membrane 300 of FIG. 2B may have a total thickness from about 20 to about 30 microns, about 20 to about 40 microns, about 20 to about 50 microns, about 20 to about 60 microns, about 20 to about 70 microns, about 20 to about 80 microns, about 20 to about 90 microns, about 20 to about 100 microns, about 20 to about 110 microns, about 20 to about 120 microns, about 20 to about 130 microns, about 20 to about 140 microns, about 20 to about 150 microns, about 30 microns to about 150 microns, about 40 microns to about 150 microns, about 50 microns to about 150 microns, about 60 microns to about 150 microns, about 70 microns to about 150 microns, about 80 microns to about 150 microns, about 90 microns to about 150 microns, about 100 microns to about 150 microns, about 110 microns to about 150 microns, about 120 microns to about 150 microns, about 130 microns to about 150 microns, about 140 microns to about 150 microns, about 30 microns to about 40 microns, about 40 microns to about 50 microns, about 50 microns to about 60 microns, about 60 microns to about 70 microns, about 80 microns to about 90 microns, about 90 microns to about 100 microns, about 100 microns to about 110 microns, about 110 microns to about 120 microns, about 120 microns to about 130 microns, or about 130 microns to about 140 microns. As another example, the composite ion exchange membrane 100 may have a total thickness of about 20 microns, about 30 microns, about 40 microns, about 50 microns, about 60 microns, about 70 microns, about 80 microns, about 90 microns, about 100 microns, about 110 microns, about 120 microns, about 130 microns, about 140 microns, or about 150 microns.

The reinforcing polymer sheet 102 may have a thickness from about 10 microns to about 40 microns. For example, the reinforcing polymer sheet 102 may have a thickness from about 10 microns to about 15 microns, about 10 microns to about 20 microns, about 10 microns to about 25 microns, about 10 microns to about 30 microns, about 10 microns to about 35 microns, about 10 microns to about 40 microns, about 15 microns to about 40 microns, about 20 microns to about 40 microns, about 25 microns to about 40 microns, about 30 microns to about 40 microns, about 35 microns to about 40 microns, about 15 microns to about 20 microns, about 20 microns to about 25 microns, about 25 microns to about 30 microns, or about 30 microns to about 35 microns. As another example, the reinforcing polymer sheet may have a thickness of about 10 microns, about 15 microns, about 20 microns, about 25 microns, about 30 microns, about 35 microns, or about 40 microns.

The first full coating layer 124 may have a thickness from about 15 microns to about 30 microns. For example, the first full coating layer 124 may have a thickness from about 15 microns to about 20 microns, about 15 microns to about 25 microns, about 15 microns to about 30 microns, about 20 microns, to about 30 microns, about 25 microns to about 30 microns, or about 20 to about 25 microns. As another example, the first full coating layer 124 may have a thickness of about 15 microns, about 20 microns, about 25 microns, or about 30 microns.

The third coating layer 116 may have a thickness from about 5 microns to about 10 microns. For example, the third coating layer 116 may have a thickness from about 5 microns to about 6 microns, about 5 microns to about 7 microns, about 5 microns to about 8 microns, about 5 microns, to about 9 microns, about 5 microns to about 10 microns, about 6 microns to about 10 microns, about 7 microns to about 10 microns, about 8 microns to about 10 microns, about 9 microns to about 10 microns, about 6 microns to about 7 microns, about 7 microns to about 8 microns, or about 8 microns to about 9 microns. As another example, the third coating layer 116 may have a thickness of about 5 microns, about 6 microns, about 7 microns, about 8 microns, about 9 microns, or about 10 microns.

The fourth coating layer 118 may have a thickness from about 5 microns to about 20 microns. For example, the fourth coating layer 118 may have a thickness from about 5 microns to about 10 microns, about 5 microns to about 15 microns, about 5 microns to about 20 microns, about 100 microns to about 20 microns, about 15 microns to about 20 microns, or about 10 to about 15 microns. As another example, the fourth coating layer 118 may have a thickness of about 5 microns, about 10 microns, about 15 microns, or about 20 microns.

### II. In-Situ Methods

Further provided herein are in-situ methods of making a composite ion exchange membrane. The composite ion exchange membrane may be any of the composite ion exchange membranes described hereinabove.

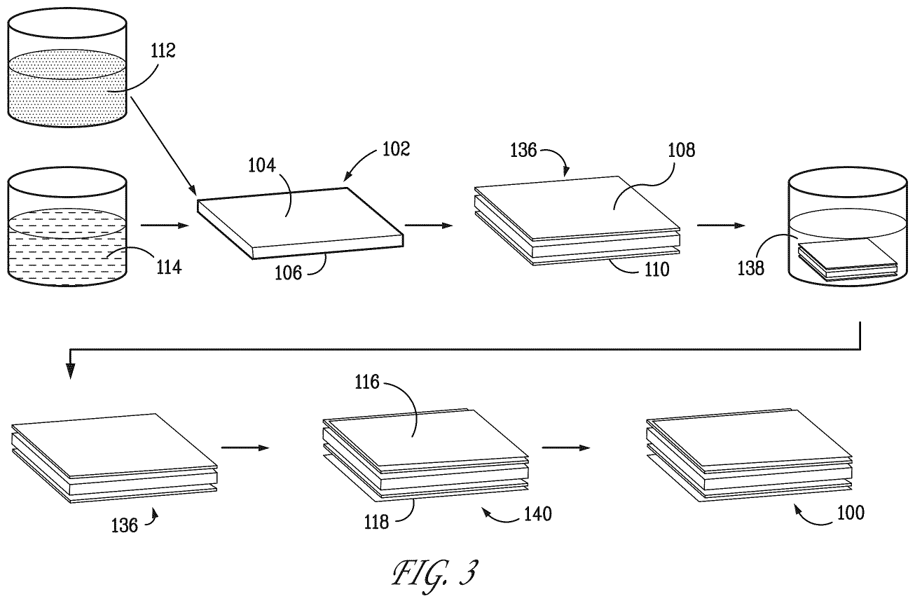

Referring now to FIG. 3, the method may comprise coating a first planar surface 104 of a reinforcing polymer sheet 102 with a first solution including an ionomer and a catalyst precursor solution and coating a second planar surface of a reinforcing polymer sheet 102 with a second solution including an ionomer and a catalyst precursor solution to form a coated reinforcing polymer sheet 136 having a first coating layer 108 and a second coating layer 110, and drying the coated reinforcing polymer sheet 136. The method further comprises immersing the coated reinforcing polymer sheet 136 in a reducing solution 138, coating the first coating layer 108 with a third solution (not shown) including an ionomer, coating the second coating layer 110 with a fourth solution (not shown) including an ionomer to form an ionomer-coated reinforcing polymer sheet 140, and drying the ionomer-coated reinforcing polymer sheet.

As depicted in FIG. 3, the first coating layer 108 may be formed by doctor blade casting the first solution 112 onto the first planar surface 104 of the reinforcing polymer sheet 102. Similarly, the second coating layer 110 may be formed by doctor blade casting the second solution 114 onto a second planar surface 106 of the reinforcing polymer sheet 102. The first planar surface 104 of the reinforcing polymer sheet 102 may be opposite the second planar surface 106, such that the first coating layer 108 and second the second coating layer 110 are coated on opposite sides of the reinforcing polymer sheet 102. In some embodiments, the first solution and the second solution may be the same solution. In another embodiment, the first solution and the second solution may be different solutions.

In some embodiments, the first solution 112 is prepared by combining an ionomer solution with a catalyst precursor. The solution may be mixed for about 30 minutes to about 12 hours at room temperature. For example, the first solution may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The ionomer solution may comprise from about 20 wt % to about 22 wt % ionomer, about 32 wt % to about 36 wt % water, and about 44 wt % to about 48 wt % organic solvent. In another example, the ionomer solution may comprise about 5 wt % to about 25 wt % ionomer, about 32 wt % to about 46 wt % water, and about 44 wt % to about 58 wt % organic solvent. For example, the ionomer solution may comprise from about 5 wt % to about 10 wt %, about 5 wt % to about 15 wt %, about 5 wt % to about 20 wt %, about 5 wt % to about 25 wt %, about 10 wt % to about 25 wt %, about 15 wt % to about 25 wt %, about 20 wt % to about 25 wt %, about 10 wt % to about 15 wt %, or about 15 wt % to about 20 wt % ionomer. The organic solvent may include butanol, isopropanol, methanol, n-propanol, ethanol, propanol, or a combination thereof. When combined with the ionomer solution, the resulting concentration of catalyst precursor present in the first solution 112 may be from about 1 wt % to about 5 wt %. In some examples the concentration of catalyst precursor in the first solution 112 may be about 1 wt %, about 2 wt %, about 3 wt %, about 4 wt %, or about 5 wt %. In some embodiments, the ionomer of the first solution 112 may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The catalyst precursor may include a scavenging catalyst. The scavenging catalyst functions to catalyze the recombination of crossover hydrogen (H₂) with oxygen (O₂) and hinder the solvation effect of membrane side chains, resulting in a poor connectivity of water and preventing diffusion of H₂ and O₂ into the membrane. The scavenging catalyst may include gold (Au), silver (Ag), nickel (Ni), platinum (Pt), zirconium dioxide (ZrO₂), titanium dioxide (TiO₂), silicon dioxide (SiO₂), or a combination thereof. For example, the catalyst precursor may be chloroplatinic acid, platinum nitrate, chloroauric acid, silver oxalate, nickel nitrate, nickel acetate, nickel chloride, titanium isopropoxide, titanium tetrabutoxide, titanium tetrachloride, or tetraethoxysilane. In one example, catalyst precursor is chloroplatinic acid and the scavenging catalyst is platinum (Pt).

The second solution 114 is prepared by combining an ionomer solution with a catalyst precursor. In some embodiments, the first solution 112 and the second solution 114 may be the same solution. The second solution 114 may be mixed for about 30 minutes to about 12 hours at room temperature. For example, the second solution 114 may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The ionomer solution may comprise from about 20 wt % to about 22 wt % ionomer, about 32 wt % to about 36 wt % water, and about 44 wt % to about 48 wt % organic solvent. In another example, the ionomer solution may comprise about 5 wt % to about 25 wt % ionomer, about 32 wt % to about 46 wt % water, and about 44 wt % to about 58 wt % organic solvent. For example, the ionomer solution may comprise from about 5 wt % to about 10 wt %, about 5 wt % to about 15 wt %, about 5 wt % to about 20 wt %, about 5 wt % to about 25 wt %, about 10 wt % to about 25 wt %, about 15 wt % to about 25 wt %, about 20 wt % to about 25 wt %, about 10 wt % to about 15 wt %, or about 15 wt % to about 20 wt % ionomer. In one example the organic solvent may include butanol, isopropanol, methanol, n-propanol, ethanol, propanol, or a combination thereof. When combined with the ionomer solution, the resulting concentration of catalyst precursor present in the second solution 114 may be from about 1 wt % to about 5 wt %. The concentration of catalyst precursor in the second solution 114 may be about 1 wt %, about 2 wt %, about 3 wt %, about 4 wt %, or about 5 wt %. In some embodiments, the ionomer of the second solution 114 may include a perfluorosulfonic acid (PSFA)-based polymer such as tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

Preferably, the catalyst precursor comprises a scavenging catalyst. The scavenging catalyst functions to catalyze the recombination of crossover hydrogen (H₂) with oxygen (O₂) and hinder the solvation effect of membrane side chains, resulting in a poor connectivity of water and preventing diffusion of H₂ and O₂ into the membrane. The scavenging catalyst may include gold (Au), silver (Ag), nickel (Ni), platinum (Pt), zirconium dioxide (ZrO₂), titanium dioxide (TiO₂), silicon dioxide (SiO₂), or a combination thereof. For example, the catalyst precursor may be chloroplatinic acid, platinum nitrate, chloroauric acid, silver oxalate, nickel nitrate, nickel acetate, nickel chloride, titanium isopropoxide, titanium tetrabutoxide, titanium tetrachloride, or tetraethoxysilane. In one example, catalyst precursor is chloroplatinic acid and the scavenging catalyst is platinum (Pt).

After the reinforcing polymer sheet 102 is coated with the first coating layer 108 and the second coating layer 110, the coated reinforcing polymer sheet 136 may be dried prior to immersion in a reducing solution 138. The coated reinforcing polymer sheet 136 may be dried at a temperature of about 50° C. to about 60° C. for about 5 minutes to about 15 minutes. In some embodiments, the coated reinforcing polymer sheet 136 is dried at a temperature of about 50° C., about 51° C., about 52° C., about 53° C., about 54° C., about 55° C., about 56° C., about 57° C., about 58° C., about 59° C., or about 60° C. for about 5 minutes, about 6 minutes, about 7 minutes, about 8 minutes, about 9 minutes, about 10 minutes, about 11 minutes, about 12 minutes, about 13 minutes, about 14 minutes, or about 15 minutes.

The reducing solution 138 may include a reducing agent which operates to anchor the scavenging catalyst within the first coating layer 108 and the second coating layer 110. The reducing agent may include NaBH₄, N₂H₄, CH₃COOH, NaHCO₃, or other reducing agents known in the art, or combinations thereof. In one example, the reducing solution 138 comprises NaBH₄. The reducing solution 138 may have a concentration of reducing agent from about 0.01 M to about 0.5 M. For example, the concentration of reducing agent may be from about 0.01 M to about 0.05 M, about 0.01 M to about 0.1 M, about 0.01 M to about 0.15 M, about 0.01 M to about 0.2 M, about 0.01 M to about 0.25 M, about 0.01 M to about 0.3 M, about 0.01 M to about 0.35 M, about 0.01 M to about 0.4 M, about 0.01 M to about 0.45 M, about 0.01 M to about 0.5 M, about 0.05 M to about 0.5 M, about 0.1 M to about 0.5 M, about 0.15 M to about 0.5 M, about 0.2 M to about 0.5 M, about 0.25 M to about 0.5 M, about 0.3 M to about 0.5 M, about 0.35 M to about 0.5 M, about 0.4 M to about 0.5 M, about 0.45 M to about 0.5 M, about 0.05 M to about 0.1 M, about 0.1 M to about 0.15 M, about 0.15 M to about 0.2 M, about 0.2 M to about 0.25 M, about 0.3 M to about 0.35 M, about 0.35 M to about 0.4 M, or about 0.4 M to about 0.45 M. As another example, the reducing agent may have a concentration of about 0.01 M, about 0.05 M, about 0.1 M, about 0.15 M, about 0.2 M, about 0.25 M, about 0.3 M, about 0.35 M, about 0.4 M, about 0.45 M, or about 0.5 M.

The coated reinforcing polymer sheet 136 may be immersed in the reducing solution 138 for about 5 minutes to about 45 minutes. For example, the coated reinforcing polymer sheet 136 may be immersed in the reducing solution 138 for about 5 minutes to about 10 minutes, about 5 minutes to about 15 minutes, about 5 minutes to about 20 minutes, about 5 minutes to about 25 minutes, about 5 minutes to about 30 minutes, about 5 minutes to about 35 minutes, about 5 minutes to about 40 minutes, about 5 minutes to about 45 minutes, about 10 minutes to about 45 minutes, about 15 minutes to about 45 minutes, about 20 minutes to about 45 minutes, about 25 minutes to about 45 minutes, about 30 minutes to about 45 minutes, about 35 minutes to about 45 minutes, about 40 minutes to about 45 minutes, about 20 minutes to about 15 minutes, about 15 minutes to about 20 minutes, about 20 minutes to about 25 minutes, about 25 minutes to about 30 minutes, about 30 minutes to about 35 minutes, or about 35 minutes to about 40 minutes. As another example, the coated reinforcing polymer sheet 136 may be immersed in the reducing solution 138 for about 5 minutes, about 10 minutes, about 15 minutes, about 20 minutes, about 25 minutes, about 30 minutes, about 35 minutes, about 40 minutes, or about 45 minutes. The coated reinforcing polymer sheet 136 may be rinsed with water and subsequently dried at a temperature of about 25° C. for about 15 minutes after immersion in the reducing solution 138.

Once dried, the first coating layer 108 of the coated reinforcing polymer sheet 136 may be coated with a third solution including an ionomer using doctor blade casting. Similarly, the second coating layer 110 of the coated reinforcing polymer sheet 136 may be coated with a fourth solution 122 including an ionomer to form an ionomer-coated reinforcing polymer sheet 140 using doctor blade casting.

The third solution may comprise from about 20 wt % to about 22 wt % ionomer, about 32 wt % to about 36 wt % water, and about 44 wt % to about 48 wt % organic solvent. Alternatively, the third solution may comprise about 10 wt % to about 12 wt % ionomer. In another example, the third solution may comprise about 5 wt % to about 25 wt % ionomer, about 32 wt % to about 46 wt % water, and about 44 wt % to about 58 wt % organic solvent. For example, the third solution may comprise from about 5 wt % to about 10 wt %, about 5 wt % to about 15 wt %, about 5 wt % to about 20 wt %, about 5 wt % to about 25 wt %, about 10 wt % to about 25 wt %, about 15 wt % to about 25 wt %, about 20 wt % to about 25 wt %, about 10 wt % to about 15 wt %, or about 15 wt % to about 20 wt % ionomer. In another example the organic solvent may include butanol, isopropanol, ethanol, propanol, or a combination thereof. In some embodiments, the ionomer of the third solution may include a perfluorosulfonic acid (PSFA) polymer such as tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™. In some embodiments, the third solution and fourth solution may be the same solution. In other embodiments, the third solution and fourth solution may be different solutions.

The fourth solution may comprise from about 20 wt % to about 22 wt % ionomer, about 32 wt % to about 36 wt % water, and about 44 wt % to about 48 wt % organic solvent. Alternatively, the fourth solution may comprise about 10 wt % to about 12 wt % ionomer. In another example, the fourth solution may comprise about 5 wt % to about 25 wt % ionomer, about 32 wt % to about 46 wt % water, and about 44 wt % to about 58 wt % organic solvent. For example, the third solution may comprise from about 5 wt % to about 10 wt %, about 5 wt % to about 15 wt %, about 5 wt % to about 20 wt %, about 5 wt % to about 25 wt %, about 10 wt % to about 25 wt %, about 15 wt % to about 25 wt %, about 20 wt % to about 25 wt %, about 10 wt % to about 15 wt %, or about 15 wt % to about 20 wt % ionomer. In another example the organic solvent may include butanol, isopropanol, ethanol, propanol, or a combination thereof. In some embodiments, the ionomer of the fourth solution may include a perfluorosulfonic acid (PSFA)-based polymer such as tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. For example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

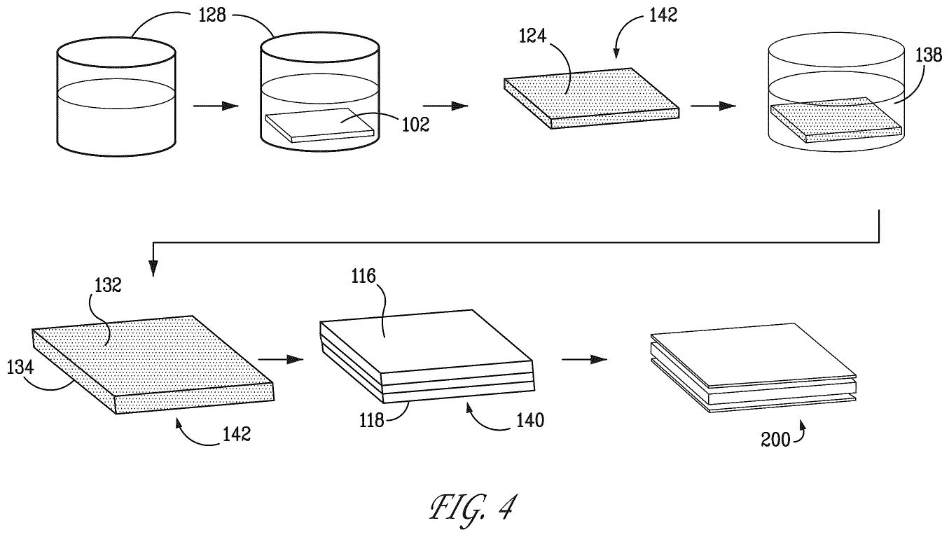

Further provided herein is a method for forming a fully coated composite ion exchange membrane 200 by dip coating as shown in FIG. 4. In these embodiments, the dip coated reinforcing polymer sheet 142 is formed by immersing the reinforcing polymer sheet 102 in a first immersion solution 128 for about 1 hour to about 12 hours. For example the reinforcing polymer sheet 102 may be immersed in the first immersion solution 128 for about 1 hour to about 2 hours, about 1 hour to about 3 hours, about 1 hour to about 4 hours, about 1 hour to about 5 hours, about 1 hour to about 6 hours, about 1 hour to about 7 hours, about 1 hour to about 8 hours, about 1 hour to about 9 hours, about 1 hour to about 10 hours, about 1 hour to about 11 hours, about 1 hour to about 12 hours, about 2 hours to about 12 hours, about 3 hours to about 12 hours, about 4 hours to about 12 hours, about 5 hours to about 12 hours, about 6 hours to about 12 hours, about 7 hours to about 12 hours, about 8 hours to about 12 hours, about 9 hours to about 12 hours, about 10 hours to about 12 hours, about 11 hours to about 12 hours, about 2 hours to about 3 hours, about 3 hours to about 4 hours, about 4 hours to about 5 hours, about 5 hours to about 6 hours, about 6 hours to about 7 hours, about 7 hours to about 8 hours, about 8 hours to about 9 hours, about 9 hours to about 10 hours, or about 10 hours to about 11 hours. As another example, the reinforcing polymer sheet 102 may be immersed in the first immersion solution 128 for about 1 hour, about 2 hours, about 3 hours, about 4 hours, about 5 hours, about 6 hours, about 7 hours, about 8 hours, about 9 hours, about 10 hours, about 11 hours, or about 12 hours. This results in a first full coating layer 124 coated on the entire surface area of the reinforcing polymer sheet 102. The dip coated reinforcing polymer sheet 142 may then be subjected to a reduction process by immersion within a reducing solution 138 followed by a water rinse and drying according to the methods described previously herein.

The first immersion solution 128 may be prepared by combining an ionomer solution with a catalyst precursor. The first immersion solution 128 may be mixed for about 30 minutes to about 12 hours at room temperature. For example, the first immersion solution 128 may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The ionomer solution may comprise from about 20 wt % to about 22 wt % ionomer, about 32 wt % to about 36 wt % water, and about 44 wt % to about 48 wt % organic solvent. In another embodiment, the ionomer solution may comprise about 5 wt % to about 25 wt % ionomer, about 32 wt % to about 46 wt % water, and about 44 wt % to about 58 wt % organic solvent. For example, the third solution may comprise from about 5 wt % to about 10 wt %, about 5 wt % to about 15 wt %, about 5 wt % to about 20 wt %, about 5 wt % to about 25 wt %, about 10 wt % to about 25 wt %, about 15 wt % to about 25 wt %, about 20 wt % to about 25 wt %, about 10 wt % to about 15 wt %, or about 15 wt % to about 20 wt % ionomer. In one example the organic solvent may include butanol, isopropanol, methanol, n-propanol, ethanol, propanol, or a combination thereof. When combined with the ionomer solution, the resulting concentration of catalyst precursor present in the first immersion solution 128 may be from about 1 wt % to about 5 wt %. In some examples, the concentration of catalyst precursor in the first immersion solution 128 is about 1 wt %, about 2 wt %, about 3 wt %, about 4 wt %, or about 5 wt %. In some embodiments, the ionomer of the first immersion solution 128 may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. In an example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The catalyst precursor may comprise a scavenging catalyst. The scavenging catalyst functions to catalyze the recombination of crossover hydrogen (H₂) with oxygen (O₂) and hinder the solvation effect of membrane side chains, resulting in a poor connectivity of water and preventing diffusion of H₂ and O₂ into the membrane. The scavenging catalyst may include gold (Au), silver (Ag), nickel (Ni), platinum (Pt), zirconium dioxide (ZrO₂), titanium dioxide (TiO₂), silicon dioxide (SiO₂), or a combination thereof. For example, the catalyst precursor may be chloroplatinic acid, platinum nitrate, chloroauric acid, silver oxalate, nickel nitrate, nickel acetate, nickel chloride, titanium isopropoxide, titanium tetrabutoxide, titanium tetrachloride, or tetraethoxysilane. In one example, catalyst precursor is chloroplatinic acid and the scavenging catalyst is platinum (Pt).

Next, a first planar surface 132 of the first full coating layer 124 may subsequently be coated with the third solution and a second planar surface 134 opposite the first planar surface 132 of the first full coating layer 124 may be coated with the fourth solution, thereby forming the third coating layer 116 and the fourth coating layer 118 on the surface of the first full coating layer 124. In one embodiment, the third coating layer 116 and the fourth coating layer 118 may be coated on the first full coating layer 124 using doctor blade casting.

In another embodiment, dip coating may be used to coat the first full coating layer 124 with a second full coating layer 126 as depicted in FIG. 2A. This may be accomplished by immersing the dip coated reinforcing polymer sheet 142 within a second immersion solution (not shown) for about 1 hour to about 12 hours. In some embodiments the dip coated reinforcing polymer sheet 142 is immersed in the second immersion solution for about 1 hour to about 2 hours, about 1 hour to about 3 hours, about 1 hour to about 4 hours, about 1 hour to about 5 hours, about 1 hour to about 6 hours, about 1 hour to about 7 hours, about 1 hour to about 8 hours, about 1 hour to about 9 hours, about 1 hour to about 10 hours, about 1 hour to about 11 hours, about 1 hour to about 12 hours, about 2 hours to about 12 hours, about 3 hours to about 12 hours, about 4 hours to about 12 hours, about 5 hours to about 12 hours, about 6 hours to about 12 hours, about 7 hours to about 12 hours, about 8 hours to about 12 hours, about 9 hours to about 12 hours, about 10 hours to about 12 hours, about 11 hours to about 12 hours, about 2 hours to about 3 hours, about 3 hours to about 4 hours, about 4 hours to about 5 hours, about 5 hours to about 6 hours, about 6 hours to about 7 hours, about 7 hours to about 8 hours, about 8 hours to about 9 hours, about 9 hours to about 10 hours, or about 10 hours to about 11 hours. As another example, the dip coated reinforcing polymer sheet 142 may be immersed in the second immersion solution for about 1 hour, about 2 hours, about 3 hours, about 4 hours, about 5 hours, about 6 hours, about 7 hours, about 8 hours, about 9 hours, about 10 hours, about 11 hours, or about 12 hours.

The second immersion solution may comprise from about 20 wt % to about 22 wt % ionomer, about 32 wt % to about 36 wt % water, and about 44 wt % to about 48 wt % organic solvent. In one example the organic solvent may include butanol, isopropanol, ethanol, propanol, or a combination thereof. Alternatively, the second immersion solution may comprise about 10 wt % to about 12 wt % ionomer. In another example, the second immersion solution may comprise about 5 wt % to about 25 wt % ionomer, about 32 wt % to about 46 wt % water, and about 44 wt % to about 58 wt % organic solvent. For example, the second immersion solution may comprise from about 5 wt % to about 10 wt %, about 5 wt % to about 15 wt %, about 5 wt % to about 20 wt %, about 5 wt % to about 25 wt %, about 10 wt % to about 25 wt %, about 15 wt % to about 25 wt %, about 20 wt % to about 25 wt %, about 10 wt % to about 15 wt %, or about 15 wt % to about 20 wt % ionomer. In some embodiments, the ionomer of the first solution may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. In an example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The in-situ methods depicted in FIGS. 3 and 4 may further include drying the ionomer-coated reinforcing polymer sheet 140 at two different temperatures. The first portion of the drying process may be carried out at a temperature from about 60° C. to about 80° C. for about 12 hours to about 16 hours to remove any organic solvent from the composite ion exchange membrane 100. The second portion of the drying process may then be carried out at a temperature from about 120° C. to about 140° C. for about 2 hours to about 4 hours in order to anneal the composite ion exchange membrane 100.

### III. Ex-Situ Methods

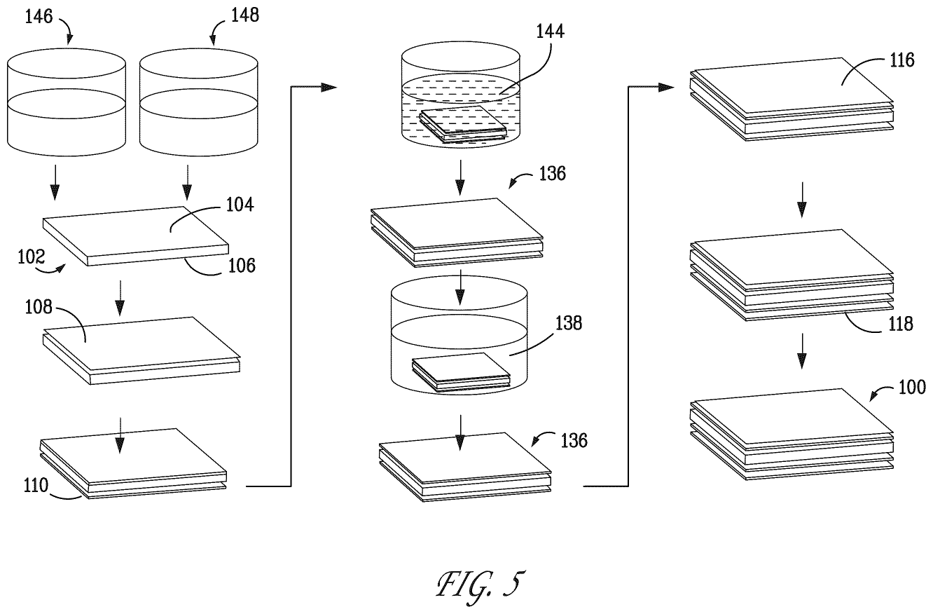

Further provided herein are ex situ methods for making a composite ion exchange membrane of the present disclosure. Referring now to FIG. 5, the methods include coating a first planar surface 104 of a reinforcing polymer sheet 102 with a first ex-situ solution 146 including an ionomer and coating a second planar surface 106 of the reinforcing polymer sheet 102 with a second ex-situ solution 148 including an ionomer to form a coated reinforcing polymer sheet 136 having a first coating layer 108 and a second coating layer 110. The coated reinforcing polymer sheet 136 is then immersed in a catalyst precursor solution 144 to embed a catalyst within the first coating layer 108 and the second coating layer 110, after which the coated reinforcing polymer sheet is dried. The methods further comprise immersing the coated reinforcing polymer sheet in a reducing solution 138, coating the first coating layer 108 with a third ex-situ solution (not shown) including an ionomer, coating the second coating layer 110 with a fourth ex-situ solution (not shown) comprising an ionomer to form an ionomer-coated reinforcing polymer sheet 140, and drying the ionomer-coated reinforcing polymer sheet 140.

As depicted in FIG. 5, the first coating layer 108 may be formed by coating the first planar surface 104 of the reinforcing polymer sheet 102 with the first ex-situ solution 146. Similarly, the second coating layer 110 may be formed by coating the second planar surface 106 of the reinforcing polymer sheet 102 with the second ex-situ solution 148. The first planar surface of the reinforcing polymer sheet 102 may be opposite the second planar surface, such that the first and second coating layers are coated upon opposite sides of the reinforcing polymer sheet 102. In one embodiment, the first coating layer 108 and the second coating layer 110 may be formed by doctor blade casting. In some embodiments, the first ex-situ solution 146 and second ex-situ solution 148 may be the same solution. In other embodiments, the first ex-situ solution 146 and second ex-situ solution 148 may be different solutions.

In some embodiments, the first ex-situ solution 146 may be prepared by combining an ionomer with a solvent. The first ex-situ solution 146 may be prepared by mixing for about 30 minutes to about 12 hours at room temperature. For example, the first ex-situ solution 146 may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The first ex-situ solution 146 may comprise from about 5 wt % to about 22 wt % ionomer, about 32 wt % to about 46 wt % water, and about 44 wt % to about 58 wt % organic solvent. For example first ex-situ solution 146 may comprise from about 5 wt % to about 10 wt %, about 5 wt % to about 15 wt %, about 5 wt % to about 20 wt %, about 5 wt % to about 22 wt %, about 10 wt % to about 22 wt %, about 15 wt % to about 22 wt %, about 20 wt % to about 22 wt %, about 10 wt % to about 15 wt %, or about 15 wt % to about 20 wt %. As another example, the first ex-situ solution 146 may comprise about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt % ionomer. The solvent may comprise an organic solvent and water. For example, the composition of the solvent may have a weight ratio of about 80:20 of organic solvent to water. In another embodiment, the first ex-situ solution 146 may comprise from about 20 wt % to about 22 wt % ionomer, about 32 wt % to about 46 wt % water, and about 44 wt % to about 58 wt % organic solvent. As an example, the organic solvent may include butanol, isopropanol, n-propanol, methanol, ethanol, propanol, or a combination thereof. As another example, the organic solvent may include isopropyl alcohol (IPA),

The ionomer of the first ex-situ solution 146 may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. In one example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The second ex-situ solution 148 may be prepared by combining an ionomer with a solvent. The second ex-situ solution 148 may be prepared by mixing for about 30 minutes to about 12 hours at room temperature. For example, the second ex-situ solution 148 may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The second ex-situ solution 148 may comprise about 5 wt % to about 22 wt % ionomer, about 32 wt % to about 46 wt % water, and about 44 wt % to about 58 wt % organic solvent. For example, second ex-situ solution 146 may comprise from about 5 wt % to about 10 wt %, about 5 wt % to about 15 wt %, about 5 wt % to about 20 wt %, about 5 wt % to about 22 wt %, about 10 wt % to about 22 wt %, about 15 wt % to about 22 wt %, about 20 wt % to about 22 wt %, about 10 wt % to about 15 wt %, or about 15 wt % to about 20 wt %. As another example, the second ex-situ solution 148 comprises about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt % ionomer. The solvent may comprise an organic solvent and water. For example, the composition of the solvent may be about 80:20 of organic solvent to water. In another embodiment, the second ex-situ solution 148 may comprise from about 20 wt % to about 22 wt % ionomer, about 32 wt % to about 46 wt % water, and about 44 wt % to about 58 wt % organic solvent. As an example, the organic solvent may include butanol, isopropanol, methanol, n-propanol, ethanol, propanol, or a combination thereof. As another example, the organic solvent may include isopropyl alcohol (IPA).

The ionomer of the second ex-situ solution 148 may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. In one example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The method shown in FIG. 5 may further comprise immersing the reinforcing polymer sheet 102 in a catalyst precursor solution 144 to embed the catalyst in the first coating layer 108 and second the coating layer 110. The coated reinforcing polymer sheet 136 may be immersed in the catalyst precursor solution 144 for about 1 hour to about 2 hours, about 1 hour to about 3 hours, about 1 hour to about 4 hours, about 1 hour to about 5 hours, about 1 hour to about 6 hours, about 1 hour to about 7 hours, about 1 hour to about 8 hours, about 1 hour to about 9 hours, about 1 hour to about 10 hours, about 1 hour to about 11 hours, about 1 hour to about 12 hours, about 2 hours to about 12 hours, about 3 hours to about 12 hours, about 4 hours to about 12 hours, about 5 hours to about 12 hours, about 6 hours to about 12 hours, about 7 hours to about 12 hours, about 8 hours to about 12 hours, about 9 hours to about 12 hours, about 10 hours to about 12 hours, or about 11 hour to about 12 hours.

The catalyst may be incorporated into the first coating layer 108 and the second coating layer 110 such that each coating layer comprises from about 1 wt % catalyst to about 5 wt % catalyst with respect to the ionomer (i.e. the weight ratio of catalyst to ionomer is from about 1:99 to about 5:95). The catalyst precursor may comprise a scavenging catalyst. The scavenging catalyst functions to catalyze the recombination of crossover hydrogen (H₂) with oxygen (O₂) and hinder the solvation effect of membrane side chains, resulting in a poor connectivity of water and preventing diffusion of H₂ and O₂ into the membrane. The scavenging catalyst may include gold (Au), silver (Ag), nickel (Ni), platinum (Pt), zirconium dioxide (ZrO₂), titanium dioxide (TiO₂), silicon dioxide (SiO₂), or a combination thereof. For example, the catalyst precursor may be chloroplatinic acid, platinum nitrate, chloroauric acid, silver oxalate, nickel nitrate, nickel acetate, nickel chloride, titanium isopropoxide, titanium tetrabutoxide, titanium tetrachloride, or tetraethoxysilane. In one example, the catalyst precursor is chloroplatinic acid and the scavenging catalyst is platinum (Pt). The concentration of the catalyst in the catalyst precursor solution 144 may be from about 1 wt % to about 5 wt %. For example, the concentration of catalyst precursor in the catalyst precursor solution 144 may be about 1 wt %, about 2 wt %, about 3 wt %, about 4 wt %, or about 5 wt %.

The methods may further include drying the coated reinforcing polymer sheet 136 after immersion in the catalyst precursor solution 144 and prior to immersion in a reducing solution 138. The coated reinforcing polymer sheet 136 may be dried at a temperature form about 50° C. to about 60° C. for about 5 minutes to about 15 minutes. In some embodiments, the coated reinforcing polymer sheet 136 may be dried at a temperature of about 50° C., 51° C., 52° C., 53° C., 54° C., 55° C., 56° C., 57° C., 58° C., 59° C., or about 60° C. for about 5 minutes, 6 minutes, 7 minutes, 8 minutes, 9 minutes, 10 minutes, 11 minutes, 12 minutes, 13 minutes, 14 minutes, or about 15 minutes.

After drying, the coated reinforcing polymer 136 sheet may be immersed in a reducing solution 138. The reducing solution 138 may comprise a reducing agent which operates to anchor the scavenging catalyst within the first coating layer 108 and the second coating layer 110. The reducing agent may include NaBH₄, N₂H₄, CH₃COOH, NaHCO₃, other reducing agents known in the art and combinations thereof. In one example, the reducing solution 138 comprises NaBH₄. The reducing solution 138 may have a concentration of reducing agent from about 0.01 M to about 0.5 M. For example, the concentration of reducing agent may be from about 0.01 M to about 0.05 M, about 0.01 M to about 0.1 M, about 0.01 M to about 0.15 M, about 0.01 M to about 0.2 M, about 0.01 M to about 0.25 M, about 0.01 M to about 0.3 M, about 0.01 M to about 0.35 M, about 0.01 M to about 0.4 M, about 0.01 M to about 0.45 M, about 0.01 M to about 0.5 M, about 0.05 M to about 0.5 M, about 0.1 M to about 0.5 M, about 0.15 M to about 0.5 M, about 0.2 M to about 0.5 M, about 0.25 M to about 0.5 M, about 0.3 M to about 0.5 M, about 0.35 M to about 0.5 M, about 0.4 M to about 0.5 M, about 0.45 M to about 0.5 M, about 0.05 M to about 0.1 M, about 0.1 M to about 0.15 M, about 0.15 M to about 0.2 M, about 0.2 M to about 0.25 M, about 0.3 M to about 0.35 M, about 0.35 M to about 0.4 M, or about 0.4 M to about 0.45 M. As another example, the reducing agent may have a concentration of about 0.01 M, about 0.05 M, about 0.1 M, about 0.15 M, about 0.2 M, about 0.25 M, about 0.3 M, about 0.35 M, about 0.4 M, about 0.45 M, or about 0.5 M.

The coated reinforcing polymer sheet 136 may be immersed in the reducing solution 138 for about 5 minutes to about 45 minutes. For example, the coated reinforcing polymer sheet 136 may be immersed in the reducing solution 138 for about 5 minutes to about 10 minutes, about 5 minutes to about 15 minutes, about 5 minutes to about 20 minutes, about 5 minutes to about 25 minutes, about 5 minutes to about 30 minutes, about 5 minutes to about 35 minutes, about 5 minutes to about 40 minutes, about 5 minutes to about 45 minutes, about 10 minutes to about 45 minutes, about 15 minutes to about 45 minutes, about 20 minutes to about 45 minutes, about 25 minutes to about 45 minutes, about 30 minutes to about 45 minutes, about 35 minutes to about 45 minutes, about 40 minutes to about 45 minutes, about 20 minutes to about 15 minutes, about 15 minutes to about 20 minutes, about 20 minutes to about 25 minutes, about 25 minutes to about 30 minutes, about 30 minutes to about 35 minutes, or about 35 minutes to about 40 minutes. As another example, the coated reinforcing polymer sheet 136 may be immersed in the reducing solution 138 for about 5 minutes, about 10 minutes, about 15 minutes, about 20 minutes, about 25 minutes, about 30 minutes, about 35 minutes, about 40 minutes, or about 45 minutes. After immersion within the reducing solution 138, the coated reinforcing polymer sheet 136 may be rinsed with water and subsequently dried at a temperature of about 25° C. for about 15 minutes.

Once dried, the first coating layer 108 of the coated reinforcing polymer sheet 136 may be coated with a third ex-situ solution including an ionomer. Similarly, the second coating layer 110 of the coated reinforcing polymer sheet may be coated with a fourth ex-situ solution including an ionomer to form an ionomer-coated reinforcing polymer sheet 140. The third ex-situ solution and fourth ex-situ solution may be coated on the first coating layer 108 and second coating layer 110 using doctor blade casting. The third ex-situ solution and fourth ex-situ solution may comprise from about 5 wt % to about 22 wt % ionomer, about 32 wt % to about 46 wt % water, and about 44 wt % to about 58 wt % organic solvent. For example, the third ex-situ solution and fourth ex-situ solution may comprise from about 5 wt % to about 10 wt %, about 5 wt % to about 15 wt %, about 5 wt % to about 20 wt %, about 5 wt % to about 22 wt %, about 10 wt % to about 22 wt %, about 15 wt % to about 22 wt %, about 20 wt % to about 22 wt %, about 10 wt % to about 15 wt %, or about 15 wt % to about 20 wt %. As another example, the third ex-situ solution and fourth ex-situ solution comprise about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt % ionomer. As another embodiment, the third ex-situ solution and fourth ex-situ solution may comprise from about 20 wt % to about 22 wt % ionomer, about 32 wt % to about 36 wt % water, and about 44 wt % to about 48 wt % organic solvent. Alternatively, the third ex-situ solution and fourth ex-situ solution may comprise about 10 wt % to about 12 wt % ionomer. In another example the organic solvent may include butanol, isopropanol, methanol, n-propanol, ethanol, propanol, or a combination thereof. In another example, the third ex-situ solution and fourth ex-situ solution may be the same solution.

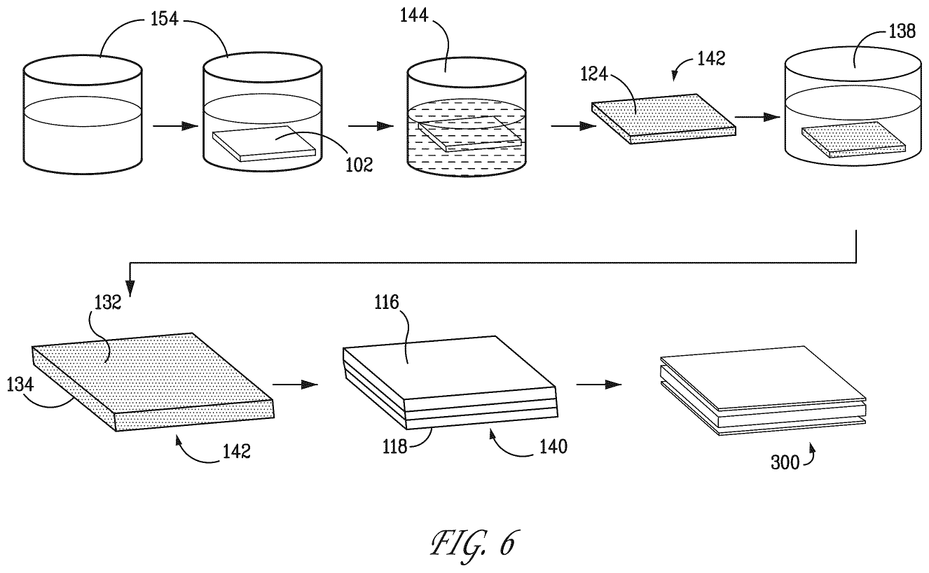

In an alternative embodiment, a fully coated composite ion exchange membrane 200 or a hybrid composite ion exchange membrane 300 may be formed by dip coating rather than doctor blade casting as shown in FIG. 6. The dip coated reinforcing polymer sheet 142 may be formed by immersing the reinforcing polymer sheet 102 in a first ex-situ immersion solution 154 for about 1 hour to about 12 hours. In some embodiments the reinforcing polymer sheet 102 is immersed in the first ex-situ immersion solution 154 for about 1 hour to about 2 hours, about 1 hour to about 3 hours, about 1 hour to about 4 hours, about 1 hour to about 5 hours, about 1 hour to about 6 hours, about 1 hour to about 7 hours, about 1 hour to about 8 hours, about 1 hour to about 9 hours, about 1 hour to about 10 hours, about 1 hour to about 11 hours, about 1 hour to about 12 hours, about 2 hours to about 12 hours, about 3 hours to about 12 hours, about 4 hours to about 12 hours, about 5 hours to about 12 hours, about 6 hours to about 12 hours, about 7 hours to about 12 hours, about 8 hours to about 12 hours, about 9 hours to about 12 hours, about 10 hours to about 12 hours, about 11 hours to about 12 hours, about 2 hours to about 3 hours, about 3 hours to about 4 hours, about 4 hours to about 5 hours, about 5 hours to about 6 hours, about 6 hours to about 7 hours, about 7 hours to about 8 hours, about 8 hours to about 9 hours, about 9 hours to about 10 hours, or about 10 hours to about 11 hours. As another example, the reinforcing polymer sheet 102 may be immersed in the first ex-situ immersion solution 154 for about 1 hour, about 2 hours, about 3 hours, about 4 hours, about 5 hours, about 6 hours, about 7 hours, about 8 hours, about 9 hours, about 10 hours, about 11 hours, or about 12 hours. This results in a first full coating layer 124 coated on the entire surface area of the reinforcing polymer sheet 102. The dip coated reinforcing polymer sheet 142 may then be subjected to a reduction process by immersion in a reducing solution 138 followed by a water rinse and drying according to the methods described previously with respect to FIG. 5.

The first ex-situ immersion solution 154 may be prepared by combining an ionomer with a solvent. The first ex-situ immersion solution 154 may be prepared by mixing for about 30 minutes to about 12 hours at room temperature. For example, the first ex-situ immersion solution 154 may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The first ex-situ immersion solution 154 may comprise from about 5 wt % to about 22 wt % ionomer, about 32 wt % to about 46 wt % water, and about 44 wt % to about 58 wt % organic solvent. For example, the first ex-situ immersion solution 154 may comprise from about 5 wt % to about 10 wt %, about 5 wt % to about 15 wt %, about 5 wt % to about 20 wt %, about 5 wt % to about 22 wt %, about 10 wt % to about 22 wt %, about 15 wt % to about 22 wt %, about 20 wt % to about 22 wt %, about 10 wt % to about 15 wt %, or about 15 wt % to about 20 wt %. As another example, the first ex-situ immersion solution 154 may comprise about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt % ionomer. The solvent may comprise an organic solvent and water. For example, the composition of the solvent may be about 80:20 of organic solvent to water. In another embodiment, the first ex-situ immersion solution 154 may comprise from about 20 wt % to about 22 wt % ionomer, about 32 wt % to about 36 wt % water, and about 44 wt % to about 48 wt % organic solvent. As an example, the organic solvent may include butanol, isopropanol, methanol, n-propanol, ethanol, propanol, or a combination thereof. As another example, the organic solvent may include isopropyl alcohol (IPA),

The ionomer of the first ex-situ immersion solution 154 may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. In one example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The method may further comprise immersing the reinforcing polymer sheet 102 in a catalyst precursor solution 144 to embed the catalyst within the first full coating layer 124. For example, the dip coated reinforcing polymer sheet 142 may be immersed in the catalyst precursor solution 144 for about 1 hour to about 2 hours, about 1 hour to about 3 hours, about 1 hour to about 4 hours, about 1 hour to about 5 hours, about 1 hour to about 6 hours, about 1 hour to about 7 hours, about 1 hour to about 8 hours, about 1 hour to about 9 hours, about 1 hour to about 10 hours, about 1 hour to about 11 hours, about 1 hour to about 12 hours, about 2 hours to about 12 hours, about 3 hours to about 12 hours, about 4 hours to about 12 hours, about 5 hours to about 12 hours, about 6 hours to about 12 hours, about 7 hours to about 12 hours, about 8 hours to about 12 hours, about 9 hours to about 12 hours, about 10 hours to about 12 hours, or about 11 hour to about 12 hours, about 2 hours to about 3 hours, about 3 hours to about 4 hours, about 4 hours to about 5 hours, about 5 hours to about 6 hours, about 6 hours to about 7 hours, about 7 hours to about 8 hours, about 8 hours to about 9 hours, about 9 hours to about 10 hours, or about 10 hours to about 11 hours. As another example, the reinforcing polymer sheet 102 may be immersed in the catalyst precursor solution 144 for about 1 hour, about 2 hours, about 3 hours, about 4 hours, about 5 hours, about 6 hours, about 7 hours, about 8 hours, about 9 hours, about 10 hours, about 11 hours, or about 12 hours.

The catalyst may be incorporated into the first full coating layer 124 such that the first full coating layer comprises about 1 wt % catalyst to about 5 wt % catalyst with respect to the ionomer (i.e., the weight ratio of catalyst to ionomer is from about 1:99 to about 5:95). The catalyst precursor may comprise a scavenging catalyst. The scavenging catalyst functions to catalyze the recombination of crossover hydrogen (H₂) with oxygen (O₂) and hinder the solvation effect of membrane side chains, resulting in a poor connectivity of water and preventing diffusion of H₂ and O₂ into the composite ion exchange membrane 100. The scavenging catalyst may include gold (Au), silver (Ag), nickel (Ni), platinum (Pt), zirconium dioxide (ZrO₂), titanium dioxide (TiO₂), silicon dioxide (SiO₂), or a combination thereof. In one example, catalyst precursor is chloroplatinic acid and the scavenging catalyst is platinum (Pt). The concentration of the catalyst in the catalyst precursor solution 144 may be from about 1 wt % to about 5 wt %. For example, the concentration of catalyst precursor in the catalyst precursor solution 144 may be about 1 wt %, about 2 wt %, about 3 wt %, about 4 wt %, or about 5 wt %.

The method may further include drying the dip coated reinforcing polymer sheet 142 after immersion in the catalyst precursor solution 144 and prior to immersion in a reducing solution 138. The dip coated reinforcing polymer sheet 142 may be dried at a temperature from about 50° C. to about 60° C. for about 5 minutes to about 15 minutes. In some embodiments, the coated reinforcing polymer sheet 136 may be dried at a temperature of about 50° C., 51° C., 52° C., 53° C., 54° C., 55° C., 56° C., 57° C., 58° C., 59° C., or about 60° C. for about 5 minutes, 6 minutes, 7 minutes, 8 minutes, 9 minutes, 10 minutes, 11 minutes, 12 minutes, 13 minutes, 14 minutes, or about 15 minutes. The dip coated reinforcing polymer sheet 142 may then be subjected to a reduction process by immersion within a reducing solution 138 followed by a water rinse and drying according to the methods described previously herein.

The method of FIG. 6 may further include coating the first planar surface 132 of the first full coating layer 124 with the third ex-situ solution and coating the second planar surface 134 opposite the first planar surface of the first coating layer with the fourth ex-situ solution to form a third coating layer 116 and a fourth coating layer 118. In one embodiment, the third coating layer 116 and the fourth coating layer 118 may be coated on the first full coating layer 124 using doctor blade casting.

Alternatively, dip coating may be used to coat the first full coating layer 124 with a second full coating layer 126. This may be accomplished by immersing the dip coated reinforcing polymer sheet 142 within a second ex-situ immersion solution 156 for about 1 hour to about 12 hours. In some embodiments the dip coated reinforcing polymer sheet 142 may be immersed in the second ex-situ immersion solution for about 1 hour to about 2 hours, about 1 hour to about 3 hours, about 1 hour to about 4 hours, about 1 hour to about 5 hours, about 1 hour to about 6 hours, about 1 hour to about 7 hours, about 1 hour to about 8 hours, about 1 hour to about 9 hours, about 1 hour to about 10 hours, about 1 hour to about 11 hours, about 1 hour to about 12 hours, about 2 hours to about 12 hours, about 3 hours to about 12 hours, about 4 hours to about 12 hours, about 5 hours to about 12 hours, about 6 hours to about 12 hours, about 7 hours to about 12 hours, about 8 hours to about 12 hours, about 9 hours to about 12 hours, about 10 hours to about 12 hours, about 11 hours to about 12 hours, about 2 hours to about 3 hours, about 3 hours to about 4 hours, about 4 hours to about 5 hours, about 5 hours to about 6 hours, about 6 hours to about 7 hours, about 7 hours to about 8 hours, about 8 hours to about 9 hours, about 9 hours to about 10 hours, or about 10 hours to about 11 hours. As another example, the dip coated reinforcing polymer sheet 142 may be immersed in the second ex-situ immersion solution 156 for about 1 hour, about 2 hours, about 3 hours, about 4 hours, about 5 hours, about 6 hours, about 7 hours, about 8 hours, about 9 hours, about 10 hours, about 11 hours, or about 12 hours.

The second ex-situ immersion solution 156 may be prepared by combining an ionomer with a solvent. The second ex-situ immersion solution 156 may be prepared by mixing for about 30 minutes to about 12 hours at room temperature. For example, the second ex-situ immersion solution 156 may be mixed for about 30 minutes to about 60 minutes, about 30 minutes to about 2 hours, about 30 minutes to about 4 hours, about 30 minutes to about 6 hours, about 30 minutes to about 8 hours, about 30 minutes to about 10 hours, about 30 minutes to about 12 hours, about 60 minutes to about 12 hours, about 2 hours to about 12 hours, about 4 hours to about 12 hours, about 6 hours to about 12 hours, about 8 hours to about 12 hours, about 10 hours to about 12 hours to about, about 60 minutes to about 2 hours, about 2 hours to about 4 hours, about 4 hours to about 6 hours, about 6 hours to about 8 hours, or about 8 hours to about 10 hours.

The second ex-situ immersion solution may comprise about 5 wt % to about 10 wt % ionomer, about 32 wt % to about 46 wt % water, and about 44 wt % to about 58 wt % organic solvent. For example, the second ex-situ immersion solution may comprise from about 5 wt % to about 10 wt %, about 5 wt % to about 15 wt %, about 5 wt % to about 20 wt %, about 5 wt % to about 22 wt %, about 10 wt % to about 22 wt %, about 15 wt % to about 22 wt %, about 20 wt % to about 22 wt %, about 10 wt % to about 15 wt %, or about 15 wt % to about 20 wt %. As another example, the second ex-situ immersion solution comprises about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt % ionomer. The solvent may comprise an organic solvent and water. For example, the composition of the solvent may be about 80:20 of organic solvent to water. In another embodiment, the second ex-situ immersion solution may comprise from about 20 wt % to about 22 wt % ionomer, about 32 wt % to about 36 wt % water, and about 44 wt % to about 48 wt % organic solvent. As an example, the organic solvent may include butanol, isopropanol, methanol, n-propanol, ethanol, propanol, or a combination thereof. As another example, the organic solvent may include isopropyl alcohol (IPA),

The ionomer of the second ex-situ immersion solution may include a perfluorosulfonic acid (PSFA)-based polymer such as a tetrafluoroethylene-based fluoropolymer-copolymer, sulphonated poly(ether-ether-ketone) (SPEEK), poly(vinyl alcohol)-poly(styrene sulfonic acid) (PVA-PSSA), chitosan, or a combination thereof. In one example, the tetrafluoroethylene-based fluoropolymer-copolymer has the formula C₇HF₁₃O₅S·CₙF₂ₙ, where n is an integer from 3,000 to 10,000. As another example, the ionomer may include Nafion™.

The methods of FIGS. 5 and 6 may further include drying the ionomer-coated reinforcing polymer sheet 140 at two different temperatures. The first portion of the drying process may be carried out at a temperature from about 60° C. to about 80° C. for about 12 hours to about 16 hours to remove any solvent from the composite ion exchange membrane 100. The second portion of the drying process may then be carried out at a temperature from about 120° C. to about 140° C. for about 2 hours to about 4 hours in order to anneal the membrane.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A method of making a composite ion exchange membrane comprising:
coating a first planar surface of a reinforcing polymer sheet with a first solution including an ionomer and a catalyst precursor solution;
coating a second planar surface of a reinforcing polymer sheet with a second solution including an ionomer and a catalyst precursor solution, thereby forming a coated reinforcing polymer sheet having a first coating layer on the first planar surface and a second coating layer on the second planar surface;
drying the coated reinforcing polymer sheet;
immersing the coated reinforcing polymer sheet in a reducing solution;
coating the first coating layer of the coated reinforcing polymer sheet with a third solution including an ionomer;
coating the second coating layer of the coated reinforcing polymer sheet with a fourth solution including an ionomer, thereby forming an ionomer-coated reinforcing polymer sheet; and
drying the ionomer-coated reinforcing polymer sheet.

2. The method of claim 1, wherein the reducing solution includes a reducing agent comprising NaBH₄, N₂H₄, CH₃COOH, or NaHCO₃.

3. The method of claim 1, wherein the reducing solution includes NaBH₄ having a concentration from about 0.01 M to about 0.5 M.

4. The method of claim 1, wherein the membrane is immersed in the reducing solution for about 5 minutes to about 45 minutes.

5. The method of claim 1, wherein the reinforcing polymer sheet includes e-PTFE, PEEK, or sPEEK.

6. The method of claim 1, wherein the reinforcing polymer sheet has a thickness from about 10 to about 40 microns.

7. The method of claim 1, wherein drying the coated reinforcing polymer sheet occurs at a temperature of about 50 to about 60° C. for about 5 minutes to about 15 minutes before immersing the membrane in the reducing solution.

8. The method of claim 1, wherein drying the ionomer-coated reinforcing polymer sheet is performed at two different temperatures, wherein the membrane is first dried at a temperature from about 60° C. to about 80° C. for about 12 hours to about 16 hours and then dried at a temperature of about 120° C. to about 140° C. for about 2 hours to about 4 hours.

9. The method of claim 1, further comprising drying the coated reinforcing polymer sheet after the immersing at a temperature of about 25° C. for about 15 minutes.

10. The method of claim 1, wherein the concentration of catalyst precursor in the first solution is from about 1 to about 5 wt %.

11. The method of claim 1, wherein the catalyst precursor comprises a scavenging catalyst selected from Au, Ag, Ni, Pt, ZrO₂, TiO₂, SiO₂, and/or CeO₂.

12. The method of claim 1, wherein the catalyst precursor comprises platinum.

13. The method of claim 1, wherein the catalyst precursor is chloroplatinic acid.

14. The method of claim 1, further comprising mixing an ionomer solution with a catalyst precursor solution for about 30 to about 60 minutes to form the first solution.

15. The method of claim 1, wherein the composite ion exchange membrane has a thickness from about 20 to about 150 microns.

16. The method of claim 1, wherein coating the first planar surface and second planar surface of the reinforcing polymer sheet is accomplished by doctor blade casting the first solution onto the reinforcing polymer sheet.

17. The method of claim 16, wherein the first solution comprises from about 20-22 wt % ionomer.

18. The method of claim 1, wherein coating the first planar surface and second planar surface of the reinforcing polymer sheet is accomplished by dip coating, wherein the first solution and the second solution are the same solution.

19. The method of claim 18, wherein the ionomer is present in the solution in amount from about 10 wt % to about 12 wt %.

20. The method of claim 18, wherein the dip coating comprises immersing the reinforcing polymer sheet in the solution for about 1 hour to about 12 hours.

21. The method of claim 1, wherein the ionomer is a perfluorosulfonic acid (PSFA) ionomer.

22. The method of claim 1, wherein the ionomer is a tetrafluoroethylene-based fluoropolymer-copolymer selected from the group consisting of, SPEEK, PVA-PSSA, chitosan, any combination thereof.

23. An ex-situ method of making a catalyst-incorporated membrane, comprising:
coating a first planar surface of a reinforcing polymer sheet with a first solution comprising an ionomer;
coating a second planar surface of the reinforcing polymer sheet with a second solution comprising an ionomer, thereby forming a coated reinforcing polymer sheet having a first coating layer on the first planar surface and a second coating layer on the second planar surface, wherein the first planar surface is opposite to the second planar surface;
immersing the coated reinforcing polymer sheet in a catalyst precursor solution to incorporate the catalyst within the first coating layer and second coating layer;
drying the coated reinforcing polymer sheet;
immersing the coated reinforcing polymer sheet in a reducing solution;
coating the first coating layer of the coated reinforcing polymer sheet with a third solution comprising an ionomer;
coating the second coating layer of the coating reinforcing polymer sheet with a fourth solution comprising an ionomer, thereby forming an ionomer-coated reinforcing polymer sheet; and
drying the ionomer-coated reinforcing polymer sheet.

24. A composite ion exchange membrane comprising:
a reinforcing polymer sheet having a first planar surface and a second planar surface, wherein the first planar surface is opposite to the second planar surface;
a first coating layer including a catalyst and an ionomer, wherein the first coating layer is coated on the first planar surface of the reinforcing polymer sheet;
a second coating layer including a catalyst and an ionomer, wherein the first coating layer is coated on the second planar surface of the reinforcing polymer sheet;
a third coating layer including an ionomer, wherein the third coating layer is coated on the first coating layer; and
a fourth coating layer including an ionomer, wherein the fourth coating layer is coated on the second coating layer.

25. A composite ion exchange membrane comprising:
a reinforcing polymer sheet having a surface area;
a first coating layer including a catalyst and an ionomer, wherein the first coating layer fully coats the entire surface area of the reinforcing polymer sheet; and
a second coating layer including an ionomer, wherein the second coating layer fully coats the first coating layer.
